(19) United States
(12) Patent Application Publication
(10) Pub. No.: US 2011/0053537 A1
(43) Pub. Date: Mar. 3, 2011

(54) FREQUENCY MODULATION RECEIVER WITH A LOW POWER FREQUENCY SYNTHESIZER

(76) Inventors: KRISHNASAWAMY NAGARAJ, Plano, TX (US); NEERAJ NAYAK, Richardson, TX (US)

(21) Appl. No.: 12/550,437

(22) Filed: Aug. 31, 2009

(51) Int. Cl. H04B 1/16

(52) U.S. Cl. 455/208

(57) ABSTRACT

A frequency modulation (FM) receiver with a low power frequency synthesizer. A FM receiver includes a low noise amplifier for processing a received input signal, a frequency synthesizer having an oscillator for generating a local oscillator signal by supplying a bias current to the oscillator, and a mixer for generating an intermediate frequency signal by mixing the received input signal with the local oscillator signal. The FM receiver further includes an analog to digital converter for converting the intermediate frequency signal to a digital signal and a bias current control module for measuring a signal strength of the received input signal based on the digital signal and for controlling the bias current.

### TECHNICAL FIELD

The present disclosure generally relates to the field of electronics, and more particularly to a frequency modulation (FM) receiver.

### BACKGROUND

A frequency modulation (FM) radio or receiver is an electronic circuit that receives its input signal from an antenna, uses electronic filters to separate a desired radio signal from all other signals picked up by the antenna, and converts the desired radio signal through demodulation. In order to separate the desired radio signal, a frequency synthesizer is used to generate a local oscillator signal that mixes with the input signal to generate the desired radio signal.

Further, a frequency of the local oscillator signal is controlled by a digitally controlled oscillator (DCO) of the frequency synthesizer which includes an inductor-capacitor (LC) circuit, a cross-coupled differential pair, and a current source as its components, where the frequency of the local oscillator signal is controlled using the capacitor of the LC circuit. In order to operate the DCO, a sizable amount of a constant bias current or power is supplied to the DCO. However, the bias current may be wasted when the strength of the input signal received is too weak to be meaningfully processed by the FM receiver.

### SUMMARY

This summary is provided to comply with 37 C.F.R. §1.73, requiring a summary of the invention briefly indicating the nature and substance of the invention. It is submitted with the understanding that it will not be used to interpret or limit the scope or meaning of the claims.

A low power frequency synthesizer for a FM receiver is disclosed. In one aspect, a FM receiver includes a low noise amplifier (LNA) for processing a received input signal, a mixer for generating an intermediate frequency signal by mixing the received input signal with a local oscillator signal, and a frequency synthesizer having an oscillator for generating the local oscillator signal. The FM receiver further includes an analog to digital converter (ADC) for converting the intermediate frequency signal to a digital signal and a bias current control module for measuring a signal strength of the received input signal based on the digital signal and for controlling a bias current used to generate the local oscillator signal.

In another aspect, a FM receiver includes a LNA for processing a received input signal, a first mixer for generating an in-phase intermediate frequency signal by mixing the received input signal with an in-phase local oscillator signal, a second mixer for generating an quadrature-phase intermediate frequency signal by mixing the received input signal with a quadrature-phase local oscillator signal, and a frequency synthesizer having a DCO for generating the in-phase local oscillator signal and the quadrature-phase local oscillator signal.

The FM receiver further includes a first variable gain amplifier (VGA) for amplifying the in-phase intermediate frequency signal, a second VGA for amplifying the quadrature-phase intermediate frequency signal, a first ADC for converting the in-phase intermediate frequency signal to an in-phase digital signal, and a second ADC for converting the quadrature-phase intermediate frequency signal to a quadrature-phase digital signal. Further, the FM receiver includes a bias current control module for measuring a signal strength of the received input signal based on the in-phase digital signal and the quadrature-phase digital signal for controlling a bias current used to generate the in-phase local oscillator signal and the quadrature-phase local oscillator signal.

In yet another aspect, in a method for reducing power consumption in a FM receiver, a signal strength of a received input signal processed by the FM receiver is measured. A size of a bias current for operating a DCO of a frequency synthesizer of the FM receiver is then determined by comparing the signal strength of the received input signal with a threshold value. Further, a control signal is generated and forwarded to the frequency synthesizer to generate the bias current of the size.

Other features of the embodiments will be apparent from the accompanying drawings and from the detailed description that follows.

### BRIEF DESCRIPTION OF THE VIEWS OF DRAWINGS

FIG. 1 illustrates a block diagram of an exemplary FM receiver with a bias current control module, according to one embodiment.

FIG. 2 illustrates a block diagram of another exemplary FM receiver with a bias current control module, according to one embodiment.

FIG. 3 illustrates an exploded view of the frequency synthesizer in the FM receiver of FIG. 2.

FIG. 4 illustrates a circuit diagram of the DCO associated with the frequency synthesizer of FIG. 3.

FIG. 5 illustrates a circuit diagram of another exemplary DCO associated with the frequency synthesizer of FIG. 3.

FIG. 6 illustrates a process flow chart of an exemplary method for reducing power consumption in the FM receiver, according to one embodiment.

The drawings described herein are for illustration purposes only and are not intended to limit the scope of the present disclosure in any way.

### DETAILED DESCRIPTION

A low power frequency synthesizer for a frequency modulation (FM) receiver is disclosed. The following description is merely exemplary in nature and is not intended to limit the present disclosure, applications, or uses. It should be understood that throughout the drawings, corresponding reference numerals indicate like or corresponding parts and features.

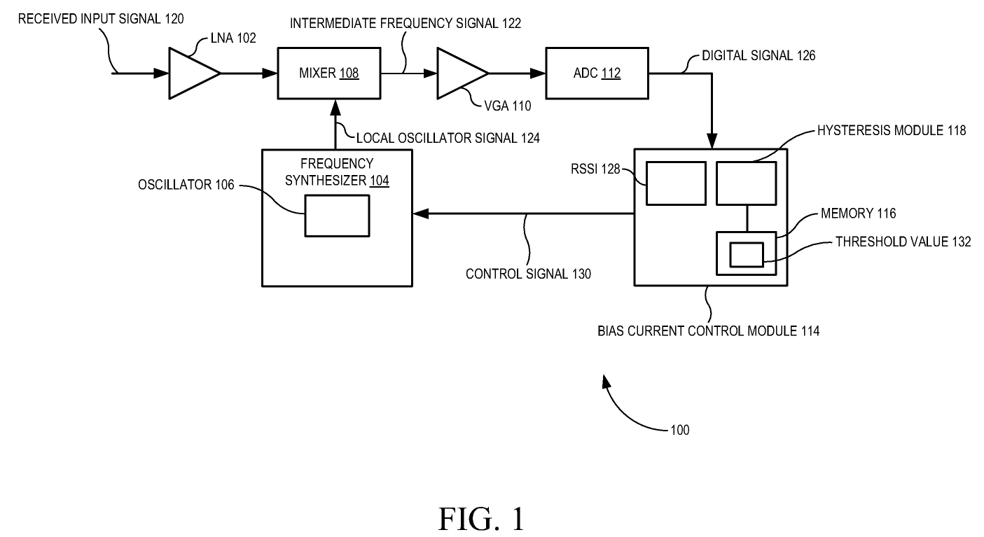

FIG. 1 illustrates a block diagram of an exemplary FM receiver 100 with a bias current control module 114, according to one embodiment. The FM receiver 100 includes a low noise amplifier (LNA) 102, a frequency synthesizer 104 including an oscillator 106, a mixer 108, a variable gain amplifier (VGA) 110, an analog to digital converter (ADC) 112, and the bias current control module 114. Further, the bias current control module 114 includes a memory 116 and a hysteresis module 118.

In operation, the LNA 102 processes an input signal 120 received from an antenna. The received input signal 120 is then forwarded to the mixer 108 to generate an intermediate frequency signal 122. In one embodiment, the intermediate frequency signal 122 is generated by mixing the received input signal 120 with a local oscillator signal 124 supplied by the frequency synthesizer 104. In one exemplary implementation, the oscillator 106 (e.g., a digitally controlled oscillator (DCO), a ring oscillator, etc.) of the frequency synthesizer 104 generates the local oscillator signal 124.

Further, the intermediate frequency signal 122 is forwarded to the VGA 110 to amplify the intermediate frequency signal 122 and then to the ADC 112 to convert the intermediate frequency signal 122 to a digital signal 126. Then, the bias current control module 114 measures a signal strength of the received input signal 120 based on the digital signal 126. The signal strength of the received input signal 120 is based on a relative signal strength indication (RSSI) 128.

In one embodiment, the bias current control module 114 controls a bias current supplied to the frequency synthesizer 104 based on the measured signal strength of the received input signal 120. Then, the bias current control module 114 generates and forwards a control signal 130 to the frequency synthesizer 104 to control the bias current. For example, the bias current is increased to generate the local oscillator signal 124 with a low phase noise if the signal strength of the received input signal 120 is greater than a threshold value 132. Alternatively, if the signal strength of the received input signal 120 is less than the threshold value 132, the bias current is decreased to generate the local oscillator signal 124 with a high phase noise.

In accordance with above described embodiments, the oscillator 106 of the frequency synthesizer 104 generates the local oscillator signal 124 based on the size of the bias current. It should be noted that, when the signal strength of the received input signal 120 is low, a higher phase noise from the frequency synthesizer 104 is acceptable from the view point of the FM receiver 100. Thus, dynamic control of the bias current to the oscillator 106 minimizes the average power consumption by the frequency synthesizer 104.

Further, the threshold value 132 is stored to the memory 116 of the bias current control module 114. The hysteresis module 118 prevents the FM receiver 100 from chattering effect. For example, when the signal strength of the received input signal 120 is substantially equal to the threshold value 132, the control signal 130 generated by the bias current control module 114 fluctuates and hence the frequency synthesizer 104 keeps varying the bias current. This may cause the FM receiver 100 to chatter. In such a case, the hysteresis module 118 enables the bias current control module 114 to maintain the control signal 130 constant for a predefined range, thereby reducing the chattering effect.

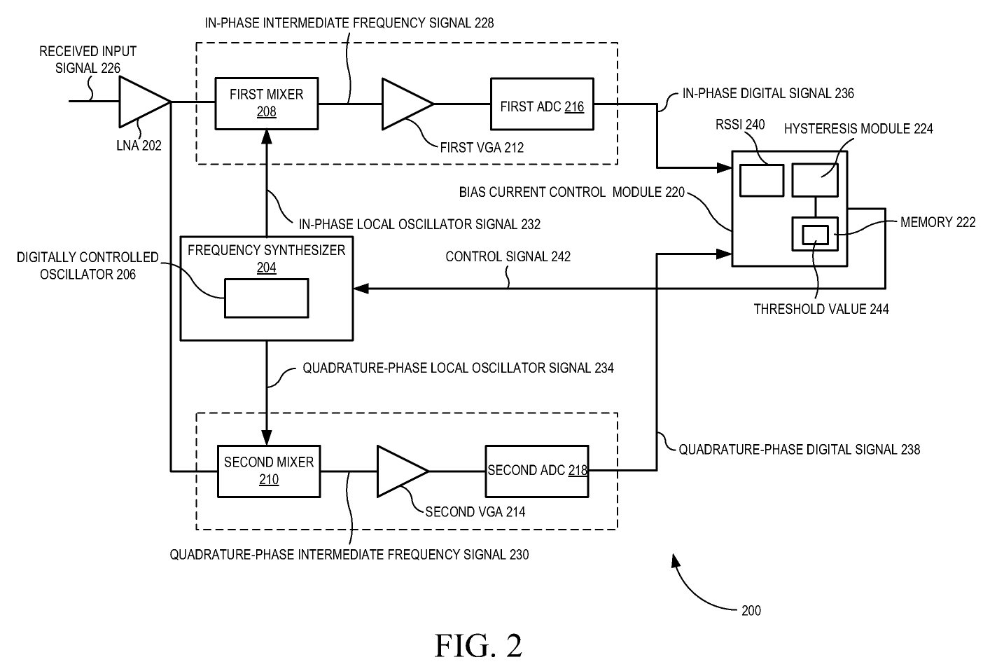

FIG. 2 illustrates a block diagram of another exemplary FM receiver 200 with a bias current control module 220, according to one embodiment. The FM receiver 200 includes an LNA 202, a frequency synthesizer 204 including a DCO 206, a first mixer 208 and a second mixer 210 coupled to the LNA 202, and a first VGA 212 and a second VGA 214 coupled to the first mixer 204 and the second mixer 206, respectively. The FM receiver 200 also includes a first ADC 216 and a second ADC 218 coupled to the first VGA 212 and the second VGA 214, respectively. Further, the FM receiver 200 includes the bias current control module 220 coupled to the first ADC 216, the second ADC 218 and to the frequency synthesizer 204. The bias control module 220 includes a memory 222 and a hysteresis module 224.

In operation, the LNA 202 processes an input signal 226 received from an antenna. The received input signal 226 is then forwarded to the first mixer 208 to generate an in-phase intermediate frequency signal 228 and to the second mixer 210 to generate a quadrature-phase intermediate frequency signal 230. In one embodiment, the in-phase intermediate frequency signal 228 is generated by mixing the received input signal 226 with an in-phase local oscillator signal 232. In another embodiment, the quadrature-phase intermediate frequency signal 230 is generated by mixing the received input signal 226 with a quadrature-phase local oscillator signal 234.

As illustrated, the frequency synthesizer 204 supplies the in-phase local oscillator signal 232 and the quadrature-phase local oscillator signal 234 to the first mixer 208 and the second mixer 210, respectively. The DCO 206 of the frequency synthesizer 204 generates the in-phase local oscillator signal 232 and the quadrature-phase local oscillator signal 234.

Further, the first VGA 212 amplifies the in-phase intermediate frequency signal 228 and the second VGA 214 amplifies the quadrature-phase intermediate frequency signal 230. Then, the first ADC 216 converts the in-phase intermediate frequency signal 228 to an in-phase digital signal 236 and the second ADC 218 converts the quadrature-phase intermediate frequency signal 230 to a quadrature-phase digital signal 238.

The bias current control module 220 then measures a signal strength of the received input signal 226 based on the in-phase digital signal 236 and a quadrature-phase digital signal 238. The signal strength of the received input signal 226 is based on a phase noise of the received input signal 226 which ranges approximately between 20 dB and 60 dB. Further, the bias current control module 220 controls a bias current, which is used to generate the in-phase local oscillator signal 232 and the quadrature-phase local oscillator signal 234 based on the measured signal strength of the received input signal 226. The bias current control module 220 generates and forwards a control signal 242 to the frequency synthesizer 204 to control the bias current.

For example, the bias current is increased to generate the in-phase local oscillator signal 232 and the quadrature-phase local oscillator signal 234 with a low phase noise if the signal strength of the received input signal 226 is greater than a threshold value 244. In an alternate embodiment, if the signal strength of the received input signal 226 is less than the threshold value 244, the bias current is decreased to generate the in-phase local oscillator signal 232 and the quadrature-phase local oscillator signal 234 with a high phase noise. In accordance with the above described embodiments, the DCO 206 of the frequency synthesizer 204 generates the in-phase local oscillator signal 232 and the quadrature-phase local oscillator signal 234 based on the size of the bias current.

Further, the threshold value 244 is stored to the memory 222 associated with the bias current control module 220. The hysteresis module 224 prevents the FM receiver 200 from chattering effect. For example, when the signal strength of the received input signal 226 is substantially equal to the threshold value 244, the control signal 242 generated by the bias current control module 220 fluctuates and hence the frequency synthesizer 204 keeps varying the bias current. This may cause the FM receiver 200 to chatter.

In such a case, the hysteresis module 224 enables the bias current control module 220 to maintain the control signal 242 constant for a predefined range, thereby reducing the chattering effect. It should be noted that, when the signal strength of the received input signal 226 is low, a higher phase noise from the frequency synthesizer 204 is acceptable from the view point of the FM receiver 200. Thus, dynamic control of the bias current to the DCO 206 minimizes the average power consumption by the frequency synthesizer 204.

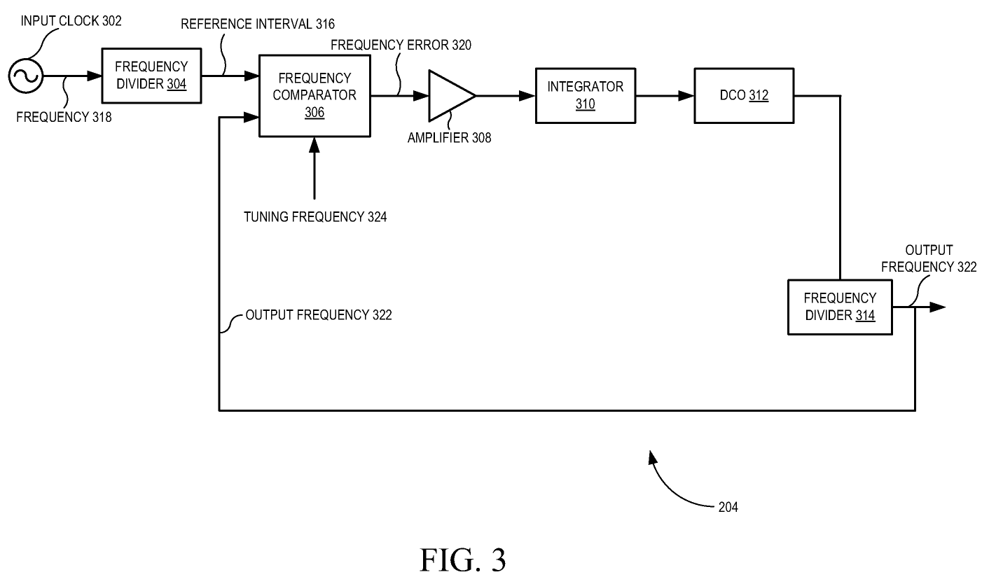

FIG. 3 illustrates an exploded view of the frequency synthesizer 204 in the FM receiver 200 of FIG. 2. The frequency synthesizer 204 includes an input clock 302, a frequency divider 304, a frequency comparator 306, an amplifier 308, an integrator 310, a DCO 312 and a frequency divider 314.

The frequency divider 304 generates a reference interval 316 by dividing a frequency 318 of the input clock 302 (e.g., 32 kHz). The frequency comparator 306 generates the frequency error 320 by comparing an output frequency 322 (e.g., ranging between 76 MHz to 108 MHz) of the frequency synthesizer 204 with a tuning frequency 324, where the tuning frequency 324 may be associated with a channel identifier (ID). In one embodiment, the frequency comparator 306 compares the output frequency 322 of the frequency synthesizer 204 with the tuning frequency 324 for the reference interval 316.

Further, the frequency error 320 is amplified by the amplifier 308 and then accumulated at the integrator 310 for a number of reference cycles. Accumulating the frequency error 320 enables inclusion of the slightest frequency error. The accumulated frequency error 320 is then used to correct the frequency of the DCO 312. In one embodiment, the DCO frequency is digitally corrected based on the frequency error 320 until the DCO frequency becomes equal to the tuning frequency 324. In another embodiment, when the value of the tuning frequency 324 changes, a frequency error is generated and the DCO frequency is corrected to a new value of the tuning frequency 324. Further, the frequency divider 314 divides the DCO frequency and outputs the output frequency 322.

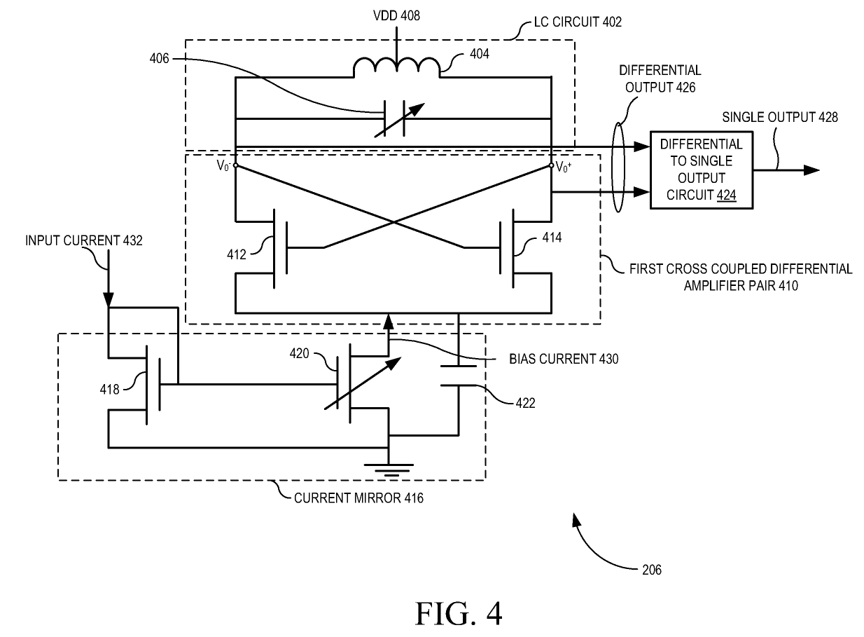

FIG. 4 illustrates a circuit diagram of the DCO 206 associated with the frequency synthesizer 204 of FIG. 3. The DCO 206 includes an inductor-capacitor (LC) circuit 402 coupled to a positive supply voltage (VDD) 408 (e.g., 1.5V). The LC circuit 402 includes an inductor 404 and a capacitor 406 (e.g., a digitally tuned capacitor array) connected in parallel. The DCO 206 also includes a first cross coupled differential amplifier pair 410 coupled to the LC circuit 402. The first cross coupled differential amplifier pair 410 includes n-channel metal-oxide-semiconductor field-effect (NMOS) transistors 412 and 414.

Further, the DCO 206 includes a current mirror 416 coupled to the first cross coupled differential amplifier pair 410. The current mirror 416 includes a NMOS transistor 418, a variable NMOS transistor 420 and a capacitor 422. The DCO 206 also includes a differential to single output circuit 424 for converting a differential output 426 of the DCO 206 to a single output 428.

In one exemplary implementation, a bias current 430 supplied to the first cross coupled differential amplifier pair 410 may be controlled by varying the size of the variable NMOS transistor 420 (e.g., where an input current 432 is supplied to the current mirror 416). The bias current 430 via the first cross coupled differential amplifier pair 410 can be varied over a vide range. As illustrated, the current mirror 416 supplies the bias current 430 to the first cross coupled differential amplifier pair 410 to generate the differential output 426 (e.g., the in-phase local oscillator signal 232 and the quadrature-phase local oscillator signal 234 of FIG. 2). In one embodiment, the frequency of the in-phase local oscillator signal 232 and the quadrature-phase local oscillator signal 234 is controlled using the capacitor 406 (e.g., the digitally tuned capacitor array) of the LC circuit 402.

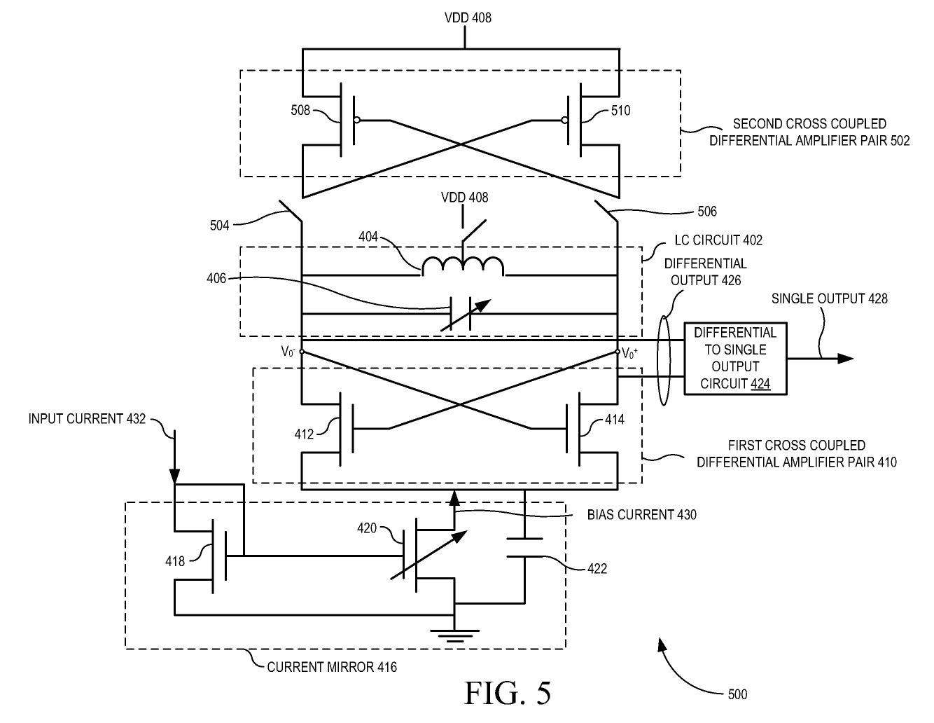

FIG. 5 illustrates a circuit diagram of another exemplary DCO 500 associated with the frequency synthesizer 204 of FIG. 3. The elements of the DCO 500 are similar to the elements of the DCO 206 of FIG. 4. The DCO 500 additionally includes a second cross coupled differential amplifier pair 502 and a pair of switches 504 and 506. The second cross coupled differential amplifier pair 502 is coupled to the LC circuit 402 and the positive supply voltage (VDD) 408. The second cross coupled differential amplifier pair 502 includes p-channel metal-oxide-semiconductor field-effect (PMOS) transistors 508 and 510.

Further, the pair of switches 504 and 506 is coupled to the second cross coupled differential amplifier pair 502. The pair of switches 504 and 506 are operable to connect the second cross coupled differential amplifier pair 502 to the first cross coupled differential amplifier pair 410 if the bias current 430 is less than a threshold bias current (e.g., which may be less than the threshold bias current for the DCO 206 of FIG. 4). It can be noted that, the DCO 500 can oscillate at a lower bias current at the expense of a phase noise. For example, the phase noise can be relaxed by 12 dB at intermediate signal levels and by worse than 30 dB at low signal levels. Further, the DCO 500 enables saving of power (e.g., up to 4 times) consumed by the frequency synthesizer 204.

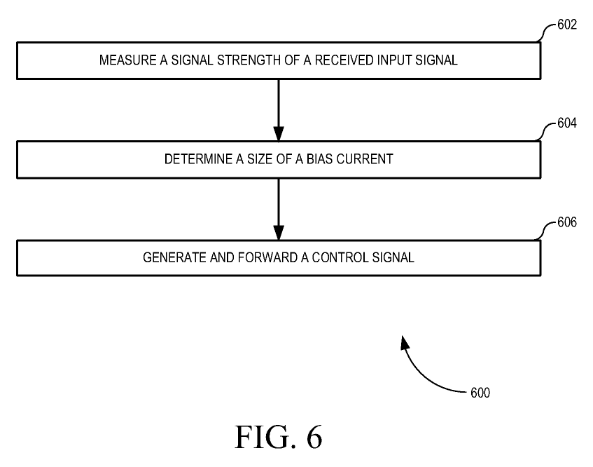

FIG. 6 illustrates a process flow chart 600 of an exemplary method for reducing power consumption in a FM receiver, according to one embodiment. In operation 602, a signal strength of a received input signal processed by the FM receiver is measured. In operation 604, a size of a bias current for operating a DCO of a frequency synthesizer of the FM receiver is determined by comparing the signal strength of the received input signal with a threshold value. In operation 606, a control signal is generated and forwarded to the frequency synthesizer to generate the bias current of the size. In one embodiment, the control signal is used to decrease the size of the bias current when the signal strength of the received input signal is lower than the threshold value. In an alternate embodiment, the control signal is used to increase the size of the bias current when the signal strength of the received input signal is higher than the threshold value. In one embodiment, the method described in FIG. 6 may be implemented using the FM receive and its components illustrated in FIG. 1 through FIG. 6.

Although, the above-described FM synthesizer 204 includes the DCO 206 or DCO 500 to generate the local oscillator signal, one can envision that the FM synthesizer 204 may include other type of oscillators (e.g., a ring oscillator) to generate the local oscillator signal. In one exemplary implementation, if the bias current goes too low, then a ring oscillator is used to generate the local oscillator signal as the ring oscillator can oscillate even at very low bias current.

The above-described FM receiver enables dynamic adjustment of the bias current to the oscillator as well as dynamic re-configuration of the oscillator itself, to minimize the overall power consumption of the FM synthesizer. The above-described FM receiver takes advantage of the fact that the FM synthesizer phase noise becomes critical under strong radio frequency (RF) input conditions as audio signal to noise ratio (SNR) is dominated by the FM synthesizer phase noise when the signal strength of the received input signal is high.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuit (ASIC)).

What is claimed is:

1. A frequency modulation receiver, comprising:
a low noise amplifier for processing a received input signal;
a frequency synthesizer having an oscillator for generating a local oscillator signal by supplying a bias current to the oscillator;
a mixer for generating an intermediate frequency signal by mixing the received input signal with the local oscillator signal;
an analog to digital converter for converting the intermediate frequency signal to a digital signal; and
a bias current control module for measuring a signal strength of the received input signal based on the digital signal and for controlling the bias current.

2. The receiver of claim 1, wherein the bias current is increased to generate the local oscillator signal with a low phase noise if the signal strength of the received input signal is greater than a threshold value, and wherein the bias current is decreased to generate the local oscillator signal with a high phase noise if the signal strength of the received input signal is less than the threshold value.

3. The receiver of claim 2, wherein the threshold value is stored to a memory associated with the bias current control module.

4. The receiver of claim 2, wherein the bias current control module comprises a hysteresis module associated with the threshold value.

5. The receiver of claim 1, wherein the signal strength of the received input signal is based on a received signal strength indication.

6. The receiver of claim 1, wherein the oscillator comprises a digitally controlled oscillator.

7. The receiver of claim 1, wherein the oscillator comprises a ring oscillator.

8. The receiver of claim 1, further comprising a variable gain amplifier for forwarding the intermediate frequency signal form the mixer to the analog to digital converter.

9. A frequency modulation receiver, comprising:
a low noise amplifier for processing a received input signal;
a frequency synthesizer having a digitally controlled oscillator for generating an in-phase local oscillator signal and a quadrature-phase local oscillator signal by supplying a bias current to the digitally controlled oscillator;
a first mixer for generating an in-phase intermediate frequency signal by mixing the received input signal with the in-phase local oscillator signal;
a second mixer for generating an quadrature-phase intermediate frequency signal by mixing the received input signal with the quadrature-phase local oscillator signal;
a first variable gain amplifier for amplifying the in-phase intermediate frequency signal;
a second variable gain amplifier for amplifying the quadrature-phase intermediate frequency signal;
a first analog to digital converter for converting the in-phase intermediate frequency signal to an in-phase digital signal;
a second analog to digital converter for converting the quadrature-phase intermediate frequency signal to a quadrature-phase digital signal; and
a bias current control module for measuring a signal strength of the received input signal based on the in-phase digital signal and the quadrature-phase digital signal and for controlling the bias current.

10. The receiver of claim 9, wherein the frequency synthesizer further comprises:
a frequency divider for generating a reference interval by dividing a frequency of an input clock;
a frequency comparator for generating a frequency error by comparing an output frequency of the frequency synthesizer with a tuning frequency;
an amplifier for amplifying the frequency error; and
an integrator for accumulating the frequency error, wherein the frequency error is processed by the digitally controlled oscillator to correct the frequency error.

11. The receiver of claim 9, wherein the digitally controlled oscillator comprises:
an inductor capacitor circuit coupled to a positive supply voltage;
a first cross coupled differential amplifier pair coupled to the inductor capacitor circuit;
a current mirror coupled to the first cross coupled differential amplifier pair; and
a differential to single output circuit for converting a differential output of the digitally controlled oscillator to a single output, wherein the bias current is supplied to the first cross coupled differential amplifier pair to generate the in-phase local oscillator signal and the quadrature-phase local oscillator signal.

12. The receiver of claim 11, wherein a frequency of the in-phase local oscillator signal and the quadrature-phase local oscillator signal is controlled using a digitally tuned capacitor array of the inductor capacitor circuit.

13. The receiver of claim 11, further comprising:
a second cross coupled differential amplifier pair coupled to the inductor capacitor circuit; and
a pair of switches coupled to the second cross coupled differential amplifier pair, wherein the pair of switches are operable to connect the second cross coupled differential amplifier pair to the first cross coupled differential amplifier pair if the bias current is less than a threshold bias current.

14. The receiver of claim 13, wherein the first cross coupled differential amplifier pair comprises two n-channel metal-oxide-semiconductor field-effect transistors and the second cross coupled differential amplifier pair comprises two p-channel metal-oxide-semiconductor field-effect transistors.

15. The receiver of claim 9, wherein the signal strength of the received input signal is based on a signal to noise ratio of the received input signal.

16. The receiver of claim 15, wherein the signal to noise ratio ranges approximately between 20 dB and 60 dB

17. The receiver of claim 11, wherein the current mirror comprises a variable n-channel metal-oxide-semiconductor field-effect transistor.

18. The receiver of claim 17, wherein the variable n-channel metaloxide-semiconductor field-effect transistor is operable for varying the bias current.

19. A method for reducing power consumption in a frequency modulation receiver, comprising:
measuring a signal strength of a received input signal processed by a frequency modulation receiver;
determining a size of a bias current for operating a digitally controlled oscillator of a frequency synthesizer of the frequency modulation receiver by comparing the signal strength of the received input signal with a threshold value; and
generating and forwarding a control signal to the frequency synthesizer to generate the bias current of the size.

20. The method of claim 19, further comprising decreasing the size of the bias current based on the control signal when the signal strength of the received input signal is lower than the threshold value.
